(19) United States
(12) Patent Application Publication
(10) Pub. No.: US 2009/0001048 A1
(43) Pub. Date: Jan. 1, 2009

(54) METHOD OF MANUFACTURING INKJET PRINTHEAD

(75) Inventors: Yong-seop YOON, Seoul (KR); Hyung Choi, Seongnam-si (KR); Moon-chul Lee, Yongin-si (KR); Yong-won Jeong, Seoul (KR); Dong-sik Shim, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 11/935,063

(22) Filed: Nov. 5, 2007

(30) Foreign Application Priority Data
Jun. 27, 2007 (KR) 2007-63827

(51) Int. Cl. G11B 5/127

(52) U.S. Cl. 216/27

(57) ABSTRACT

A method of manufacturing an inkjet printhead includes forming a chamber layer, in which a plurality of ink chambers is formed, on a substrate, forming trench to define an island surrounded by the trench on an upper part of the substrate by etching an upper surface of the substrate to a predetermined depth, forming a sacrifice layer on the chamber layer to fill the trenches and the ink chambers, forming a nozzle layer, in which a plurality of nozzles are formed, on the sacrifice layer and the chamber layer, forming an ink feed hole by etching a lower part of the substrate until the sacrifice layer that is filled in the trench is exposed, and removing the sacrifice layer and the island.

### CROSS-REFERENCE TO RELATED APPLICATIONS

This application claims priority under 35 U.S.C. §119(a) from Korean Patent Application No. 10-2007-0063827, filed on Jun. 27, 2007, in the Korean Intellectual Property Office, the disclosure of which is incorporated herein in its entirety by reference.

### BACKGROUND OF THE INVENTION

1. Field of the Invention

The present general inventive concept relates to a method of manufacturing an inkjet printhead, and more particularly, to a method of manufacturing a thermal inkjet printhead that can reduce manufacturing costs and can increase productivity by simplifying the manufacturing process.

2. Description of the Related Art

An inkjet printhead is a device for printing a predetermined color image by ejecting minute ink droplets on desired areas of a printing medium, such as paper. Inkjet printheads can be generally classified into two types according to the ejection mechanism of the ink droplets. The first type is a thermal inkjet printhead that ejects ink droplets using an expansion force of ink bubbles created using a heat source, and the second type is a piezoelectric inkjet printhead that ejects inkjet droplets using a pressure created by a deformation of a piezoelectric element.

An ink droplet ejection mechanism in a thermal inkjet printhead will now be described in more detail. When a pulse type current is applied to a heater that is formed of a resistive heating element, heat is generated from the heater and ink adjacent to the heater is instantly heated to approximately 300° C. Thus, the ink boils and generates ink bubbles. The ink bubbles expand so as to apply a pressure to the ink filled in an ink chamber. Therefore, the ink adjacent to nozzles is ejected to an outside of the ink chamber in the form of droplets.

FIGS. 1 through 5 are cross-sectional views illustrating a method of manufacturing a conventional thermal inkjet printhead. Referring to FIG. 1, an insulating layer 12 is formed on a top surface of a substrate 10, and a plurality of heaters 16 and a plurality of electrodes 17 are sequentially formed on the insulating layer 12. After forming a passivation layer 18 covering the heaters 16 and the electrodes 17 on the insulating layer 12, an anti-cavitation layer 19 is formed on the passivation layer 18. The anti-cavitation layer 19 protects the heaters 16 from being damaged by a cavitation force generated when the bubbles collapse. Then, a chamber layer 20 that includes ink chambers 22 is formed on the substrate 10 on which a plurality of material layers is formed. Trenches 13 having a predetermined depth are formed by sequentially etching the passivation layer 18, the insulating layer 12, and the upper portion the substrate 10 such that the trenches 13 can have a depth of approximately 50 μm. Referring to FIG. 2, a sacrifice layer 25 that fills the trenches 13 and the chamber layer 20 is formed on the chamber layer 20. Referring to FIG. 3, an upper surface of the sacrifice layer 25 is planarized using, for example, a chemical mechanical polishing (CMP) method, such that top surfaces of the chamber layer 20 and the sacrifice layer 25 are flush with each other. Referring to FIG. 4, a nozzle layer 30 that includes nozzles 32 is formed on the upper surface of the sacrifice layer 25 and the chamber layer 20. An ink feed hole 11 is formed by etching a lower part of the substrate 10 so that the sacrifice layer 25 filled in the trenches 13 is exposed. Referring to FIG. 5, the manufacture of the conventional inkjet printhead is completed by removing the sacrifice layer 25 filled in the trenches 13 and the ink chambers 22.

However, in the method of manufacturing the conventional inkjet printhead as described above, coating process and curing process must be performed repeatedly at least three times so as to form the sacrifice layer 25 that fills in the trenches 13 and the ink chambers 22. Therefore, such manufacturing process is complicated, thereby increasing manufacturing costs.

### SUMMARY OF THE INVENTION

The present general inventive concept provides a method of manufacturing an inkjet printhead that can reduce manufacturing costs and can increase productivity by simplifying the manufacturing process.

Additional aspects and utilities of the present general inventive concept will be set forth in part in the description which follows and, in part, will be obvious from the description, or may be learned by practice of the general inventive concept.

The foregoing and/or other aspects and utilities of the present general inventive concept are achieved by providing a method of manufacturing an inkjet printhead, including forming a chamber layer, in which a plurality of ink chambers is formed, on a substrate, forming a trench and an island surrounded by the trench on an upper part of the substrate by etching an upper surface of the substrate to a predetermined depth, forming a sacrifice layer on the chamber layer to fill the trench and the ink chambers, forming a nozzle layer, in which a plurality of nozzles are formed, on the sacrifice layer and the chamber layer, forming an ink feed hole by etching a lower part of the substrate until the sacrifice layer that is filled in the trench is exposed, and removing the sacrifice layer and the island.

The island formed by the trenches may have a width narrower than that of the ink feed hole. The removing of the sacrifice layer and the island may include removing the island to an outside through the ink feed hole in the process of removing the sacrifice layer by etching.

The method may further include planarizing upper surfaces of the sacrifice layer and the chamber layer after the sacrifice layer is formed. The upper surfaces of the sacrifice layer and the chamber layer may be planarized using a chemical mechanical polishing (CMP) process.

The method may further include, forming an insulating layer on the substrate, sequentially forming a plurality of heaters and electrodes on the upper surface of the insulating layer, and forming a passivation layer covering the heaters and the electrodes on the insulating layer, wherein the forming of the insulating layer on the substrate takes place before the forming of the chamber layer on the substrate.

The forming of the trench and the island may include forming a through hole that exposes the upper surface of the substrate by sequentially etching the passivation layer and the insulating layer, exposing and developing a photoresist after coating the photoresist to cover an upper surface of the substrate exposed through the through hole, etching the substrate to a predetermined depth using the developed photoresist as an etch mask, and removing the photoresist.

The method may further include forming anti-cavitation layers on an upper surface of the passivation layer after the passivation layer is formed.

The sacrifice layer may be formed of a material having an etch selectivity with respect to the substrate, the chamber layer, and the nozzle layer.

The foregoing and/or other aspects and utilities of the present general inventive concept are also achieved by providing a method of manufacturing an inkjet printhead including forming a chamber layer, in which a plurality of ink chambers is formed, on a substrate, forming trenches to define an island between the trenches, and at least one bridge that connects the island and the substrate on an upper part of the substrate by etching the upper part of the substrate to a predetermined depth, forming a sacrifice layer on the chamber layer to fill the trenches and the ink chambers, forming a nozzle layer, in which a plurality of nozzles are formed, on the sacrifice layer and the chamber layer, forming an ink feed hole by etching the lower part of the substrate until the sacrifice layer that is filled in the trenches is exposed, and removing the sacrifice layer.

The island formed by the trenches may have a width narrower than that of the ink feed hole. The removing of the sacrifice layer may include leaving the island connected to the substrate through the at least one bridge.

The foregoing and/or other aspects and utilities of the present general inventive concept are also achieved by providing a method to manufacture an inkjet printhead, the method including forming an insulating layer on a substrate; forming a chamber layer on an upper surface of the substrate to define a plurality of ink chambers, etching the substrate and the insulating layer to form a plurality of trenches to define an island at a portion of the substrate corresponding to an ink supply hole, forming a sacrifice layer over the substrate, insulating layer, and chamber layer such that the sacrifice layer is also formed within the trenches defining the island, forming a nozzle layer defining a plurality of nozzles over the sacrifice layer, such that the nozzles correspond to the ink chambers, forming the ink feed hole through a lower part of the substrate until the sacrifice layer filled in the trenches is exposed, and removing the sacrifice layer.

The etching of the substrate and the insulating layer to form a plurality of trenches may include forming a plurality of trenches that surround the island such that the island is removed through the ink feed hole when the sacrifice layer is removed.

The etching of the substrate and the insulating layer to form a plurality of trenches may include forming a plurality of trenches to surround the island such that a plurality of bridges remain to connect the island to the substrate, wherein after the sacrifice layer is removed, a gap is defined between the island and the substrate to filter an ink supplied to the ink chambers.

The gap may be defined to correspond to a diameter of the nozzles.

The method may further include sequentially forming a plurality of heaters and electrodes on an upper surface of the insulating layer to correspond with the ink chambers, and sequentially forming a passivation layer and an anti-cavitation layer to cover the heaters and the electrodes formed on the insulating layer.

The etching of the substrate and the insulating layer to form a plurality of trenches may include etching through at least one of heaters, electrodes, passivation layer, and anti-cavitation layer to define the island at the portion of the substrate corresponding to the ink supply hole.

### BRIEF DESCRIPTION OF THE DRAWINGS

These and/or other aspects and utilities of the present general inventive concept will become apparent and more readily appreciated from the following description of the embodiments, taken in conjunction with the accompanying drawings of which:

FIGS. 1 through 5 are cross-sectional views illustrating a method of manufacturing a conventional thermal inkjet printhead;

FIGS. 6 through 8 and 10 through 14 are cross-sectional views illustrating a method of manufacturing a thermal inkjet printhead according to an embodiment of the present general inventive concept;

FIG. 9 is a perspective view of FIG. 8;

FIGS. 15, 16, and 18 through 22 are cross-sectional views illustrating a method of manufacturing a thermal inkjet printhead according to another embodiment of the present general inventive concept;

FIG. 17 is a perspective view of FIG. 16; and

FIG. 23 is an exploded perspective view of FIG. 22.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures. In the drawings, the thicknesses of layers and regions are exaggerated for clarity, and like reference numerals refer to the like elements. The general inventive concept may, however, be embodied in many different forms and should not be construed as being limited to the embodiments set forth herein; rather, these embodiments are provided so that this disclosure will be thorough and complete, and will fully convey the concept of the general inventive concept to those skilled in the art. It will also be understood that when a layer is referred to as being “on” another layer or substrate, it can be directly on the other layer or substrate, or intervening layers may also be present. Constituent elements of an inkjet printhead can be formed of a material different from the exemplary material described below, and in the method of manufacturing the inkjet printhead, the order of operations may be different from described below.

FIGS. 6 through 14 are cross-sectional views illustrating a method of manufacturing a thermal inkjet printhead according to an embodiment of the present general inventive concept.

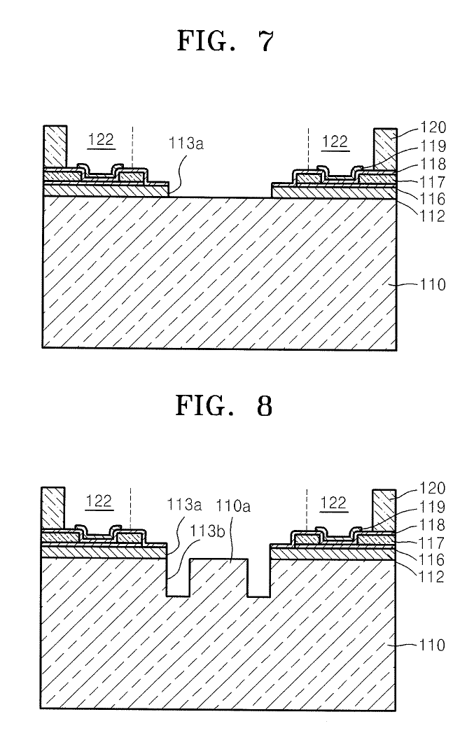

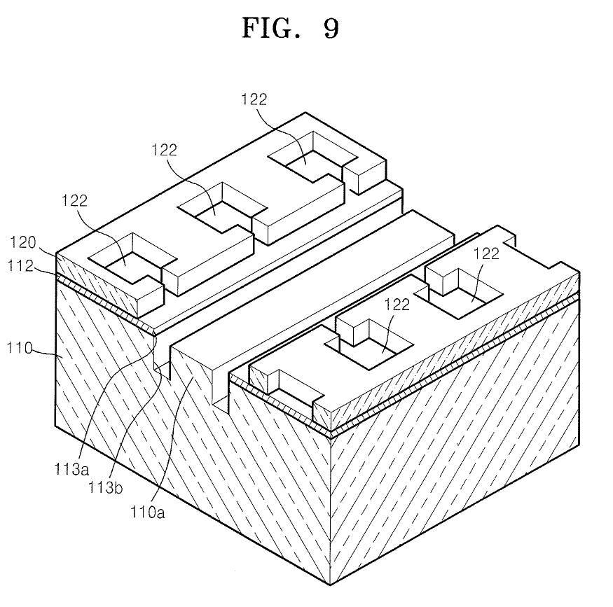

FIG. 9 is a perspective view of FIG. 8.

Referring to FIG. 6, an insulating layer 112 is formed on an upper surface of a substrate 110, such as, for example, a silicon substrate. The insulating layer 112 insulates the substrate 110 from a plurality of heaters 116 that are formed on the insulating layer 112. The insulating layer 112 can be formed of, for example, silicon oxide. The heaters 116 are formed on an upper surface of the insulating layer 112. The heaters 116 can be formed by patterning a resistive heating element after depositing the resistive heating element, such as, for example, Ta—Al alloy, tantalum nitride, titanium nitride, or tungsten silicide, on the upper surface of the insulating layer 112. A plurality of electrodes 117 to apply a current to the heaters 116 are formed on an upper surface of the heaters 116. The electrodes 117 can be formed by patterning a metal having high electrical conductivity, such as, for example Al, Al alloy, Au, or Ag, after depositing the metal on the upper surface of the heaters 116.

A passivation layer 118 covering the heaters 116 and the electrodes 117 can be formed on the insulating layer 112, and the passivation layer 118 prevents the heaters 116 and the electrodes 117 from being corroded or oxidized by contacting ink, and can be formed of, for example, silicon nitride or silicon oxide. Anti-cavitation layers 119 can further be formed on an upper surface of the passivation layer 118. The anti-cavitation layers 119 protect the heaters 116 from a cavitation force generated when bubbles collapse, and can be formed of for example Ta.

Referring to FIG. 7, a chamber layer 120, in which a plurality of ink chambers 122 are formed, is formed on the passivation layer 118. The chamber layer 120 can be formed by patterning a material after coating the material, for example, a photosensitive epoxy resin to a predetermined thickness covering the structure of FIG. 6. Thus, the ink chambers 122, in which ink supplied from an ink feed hole 111 (refer to FIG. 14) is filled, are formed in the chamber layer 120. The ink chambers 122 can be disposed at sides of the ink feed hole 111 that is to supply ink to the ink chambers 122. A through hole 113a that exposes an upper surface of the substrate 110 is formed by sequentially etching the passivation layer 118 and the insulating layer 112, and the through hole 113a can be formed above the ink feed hole 111 (refer to FIG. 13), that is, between the ink chambers 122 facing each other.

Referring to FIGS. 8 and 9, a trench 113b having a predetermined shape and an island 110a surrounded by the trench 113b are formed by etching the upper surface of the substrate 110 exposed through the through hole 113a. The trench 113b and the island 110a can be formed above the ink feed hole 111 as described later. For convenience of illustrating, the heaters 116, the electrodes 117, the passivation layer 118, and the anti-cavitation layers 119 are not illustrated in FIG. 9.

A process of forming the trench 113b and the island 110a will now be described. First, a photoresist (not illustrated) covering the substrate 110 that is exposed through the through hole 113a is coated. Then, after preparing a photomask (not illustrated) having a predetermined pattern above the photoresist, the photoresist is exposed and developed. Then, the substrate 110 is dry etched to a predetermined depth using the developed photoresist as an etch mask. Thus, the trench 113b that is connected to the through hole 113a and the island 110a surrounded by the trench 113b are formed. Thus, the island 110a is a part of the substrate 110, and can be formed parallel to the ink feed hole 111, and can have a width narrower than that of the ink feed hole 111 so that the island 110a can be removed to the outside through the ink feed hole 111 in a subsequent sacrifice layer removing process (refer to FIG. 14) which will be described later. The trenches 113b are formed to have a depth equal to the height of the island 110a, that is, the trenches 113b may have a depth of, for example, 30 to 100 μm, however, more preferably, approximately 50 μm.

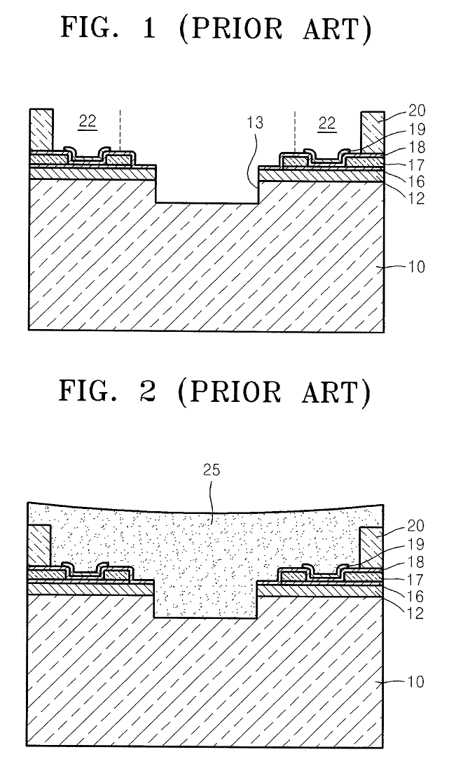

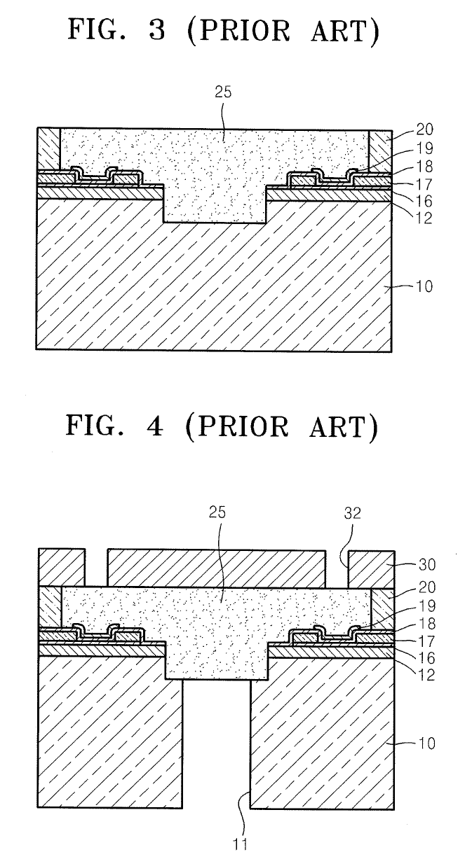

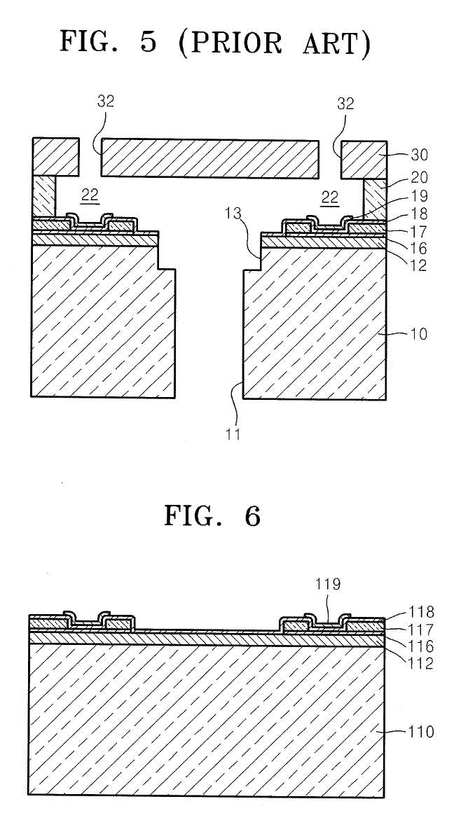

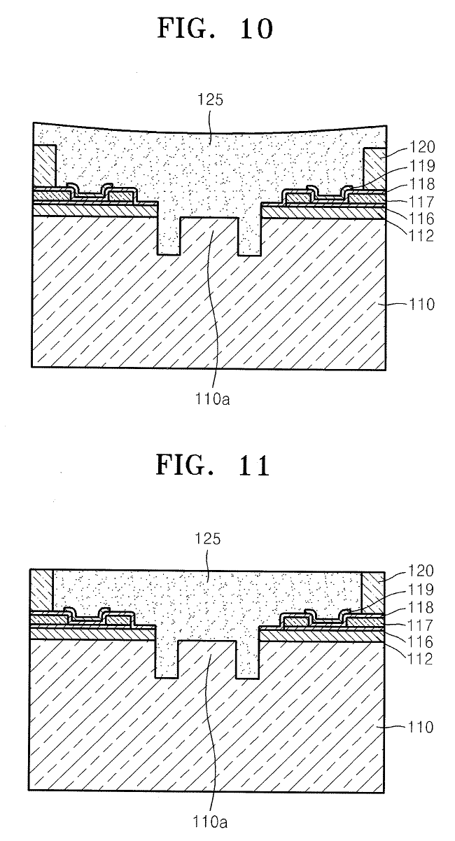

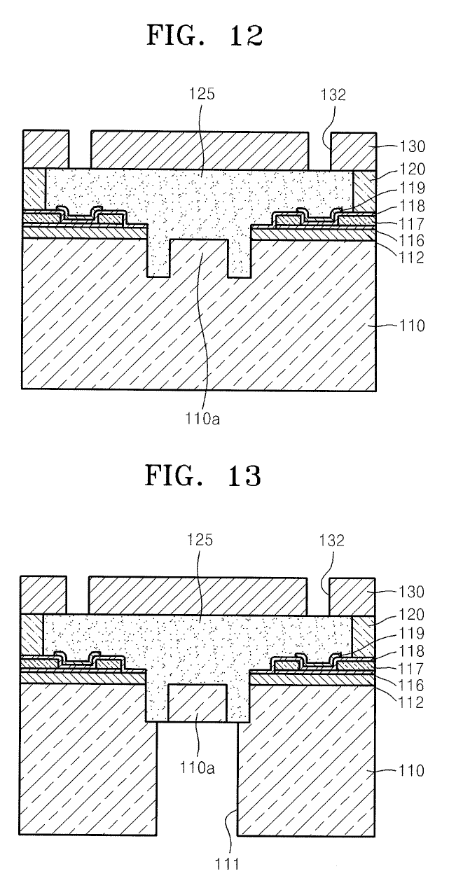

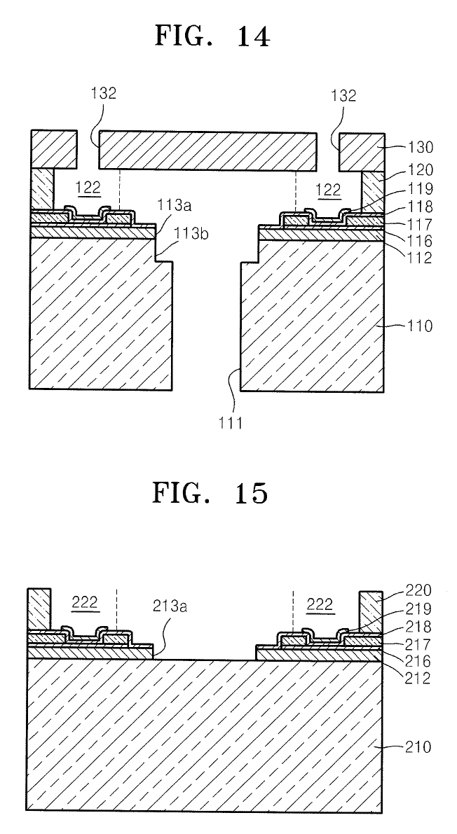

Referring to FIG. 10, a sacrifice layer 125 that fills the trenches 113b, the through hole 113a, and the ink chambers 122 is formed on the chamber layer 120. More specifically, the sacrifice layer 125 can be formed by curing a predetermined material after coating the material on the structure of FIG. 8. In the present embodiment, since the island 110a that is surrounded by the trench 113b is formed on the upper part of the substrate 110, the amount of the sacrifice layer 125 that fills in the trenches 113b is reduced as compared to the conventional method illustrated in FIGS. 1-5. Thus, the processes of coating and curing to form the sacrifice layer 125 are reduced, thereby simplifying the process of manufacturing the inkjet printhead. Also, the sacrifice layer 125 can be formed of a material, for example, a photoresist, having an etch selectivity with respect to the substrate 110, the chamber layer 120, and a nozzle layer 130 (refer to FIG. 12) which will be described later.

Referring to FIG. 11, after forming the sacrifice layer 125, a process of planarizing upper surfaces of the chamber layer 120 and the sacrifice layer 125 can further be performed. The upper surfaces of the chamber layer 120 and the sacrifice layer 125 can be planarized using, for example, a chemical mechanical polishing (CMP) method. Referring to FIG. 12, a nozzle layer 130, in which a plurality of nozzles 132 is formed, is formed on the upper surface of the chamber layer 120 and the sacrifice layer 125. The nozzle layer 130 can be formed by patterning a predetermined material after coating the predetermined material, such as a photosensitive epoxy resin, on the chamber layer 120 and the sacrifice layer 125. Thus, the nozzles 132 that expose the upper surface of the sacrifice layer 125 are formed in the nozzle layer 130. The nozzles 132 can be formed above ink chambers 122.

Referring to FIG. 13, the ink feed hole 111, to supply ink to the ink chambers 122, is formed by etching a lower part of the substrate 110 until the sacrifice layer 125, which is filled in the trenches 113b, is exposed. Also, the ink feed hole 111 can be formed to have a width greater than that of the island 110a. Finally, referring to FIG. 14, when the sacrifice layer 125 that is filled in the trenches 113b, the through hole 113a, the ink chambers 122, and the island 110a in the sacrifice layer 125 are removed, the manufacture of the inkjet printhead according to an embodiment of the present general inventive concept is completed. More specifically, when a predetermined etching solution is injected through the nozzles 132 and the ink feed hole 111, the sacrifice layer 125 is selectively etched and removed, and in this process, the island 110a is removed to the outside through the ink feed hole 111. Thus, the ink feed hole 111 is connected to the trenches 113b and ink in the ink feed hole 111 can be supplied to the ink chambers 122 through the trenches 113b and the through hole 113a.

In this way, in the method of manufacturing an inkjet printhead according to an embodiment of the present general inventive concept, since the island 110a surrounded by the trenches 113 is formed on the upper part of the substrate 110, the amount of the sacrifice layer 125 that must be filled in the trenches 113b can be greatly reduced, and as a result, the processes of coating and curing to form the sacrifice layer 125 can be reduced. Thus, the processes of the inkjet printhead can be simplified, thereby reducing manufacturing costs and increasing productivity.

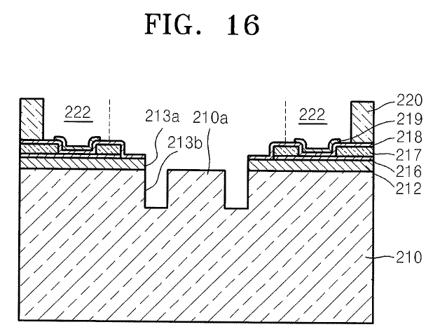

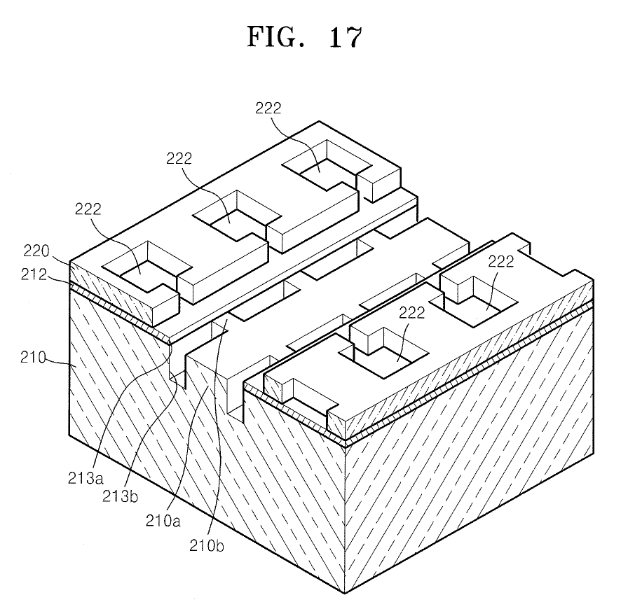

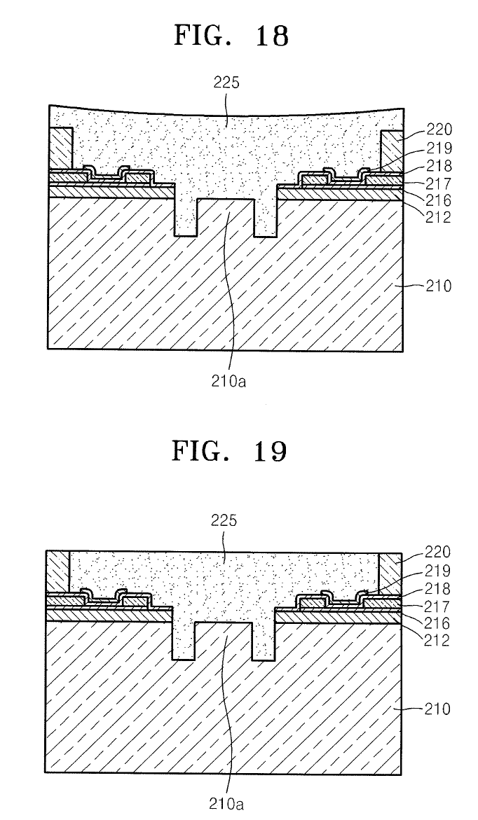

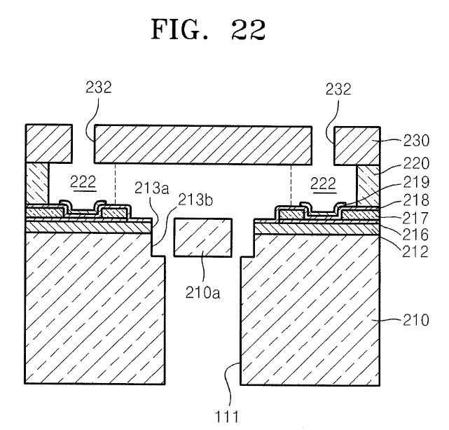

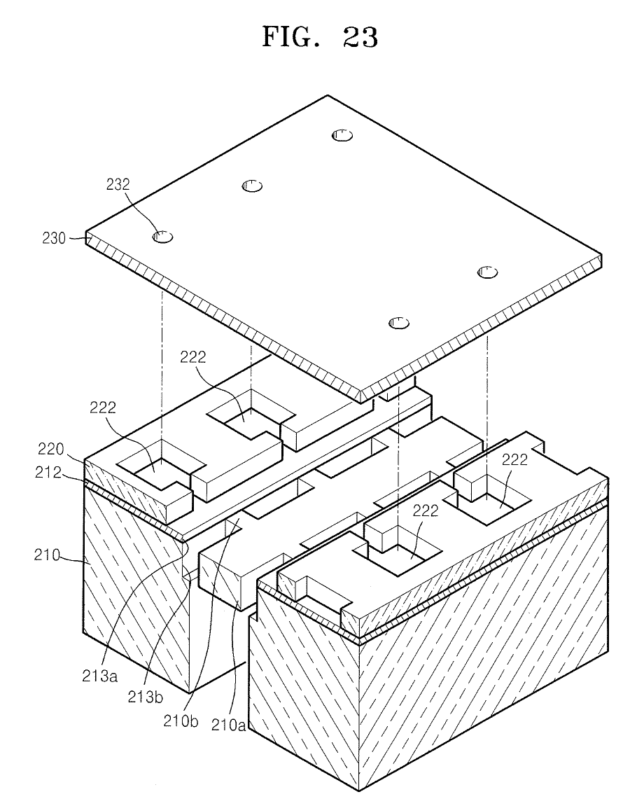

A method of manufacturing an inkjet printhead according to another embodiment of the present general inventive concept will now be described. FIGS. 15, 16, and 18 through 22 are cross-sectional views illustrating a method of manufacturing a thermal inkjet printhead according to another embodiment of the present general inventive concept. FIGS. 17 and 23 are perspective views of FIGS. 16 and 22 respectively.

Referring to FIG. 15, an insulating layer 212, a plurality of heaters 216, and a plurality of electrodes 217 are sequentially formed on a substrate 210. Then, a passivation layer 218 is formed to cover the heaters 216 and the electrodes 217 on the insulating layer 212, and anti-cavitation layers 219 are formed on the passivation layer 218. Then, a chamber layer 220, in which a plurality of ink chambers 222 are formed, is formed on the passivation layer 218, and a through hole 213a that exposes an upper surface of the substrate 210 is formed by sequentially etching the passivation layer 218, and the insulating layer 212. The ink chambers 222 can be disposed at both sides of an ink feed hole 211 (refer to FIG. 22) which will be described later, and the through hole 213a can be formed above the ink feed hole 211, that is, between the ink chambers 222 facing each other. The above processes are similar to the processes described in the previous embodiment, and thus, a detailed description thereof will not be repeated.

Referring to FIGS. 16 and 17, trenches 213b having a predetermined shape, an island 210a, and at least one bridge 210b are formed on the upper part of the substrate 210 by etching a top surface of the substrate 210 through the through hole 213a. The trenches 213b are formed to surround the island 210a except where the bridges 210b are formed to connect the island 210a and the substrate 210. The trenches 213b, the island 210a, and the bridges 210b can be formed above the ink feed hole 211. In FIG. 17, for convenience of explanation, the heaters 216, the electrodes 217, the passivation layer 218, and the anti-cavitation layers 219 are not illustrated.

The process of manufacturing the trenches 213b, the island 210a, and the bridges 210b will now be described in detail. First, a photoresist (not illustrated) is coated to cover an upper surface of the substrate 210 exposed though the through hole 213a. Next, after preparing a photomask (not illustrated) having a predetermined pattern above the photoresist, the photoresist is exposed and developed. When the substrate 210 is dry etched to a predetermined depth using the developed photoresist as an etch mask, the trenches 213b that are connected to the through hole 213a, the island 210a surround by the trenches 213b, and the bridges 210b that connect the island 210a and the substrate 210 are formed on the upper part of the substrate 210. The island 210a is a part of the substrate 210, and can have a width narrower than that of the ink feed hole 211 in a direction parallel to the ink feed hole 211. The bridges 210b are a part of the substrate 210 and allow the island 210a to remain on an upper part of the ink feed hole 211 in a process of removing a sacrifice layer as described later by connecting the island 210a and the substrate 210. The trenches 213b can be formed to have a depth equal to the height of the island 210a, that is, a depth of 30 to 100 μm, and preferably approximately 50 μm.

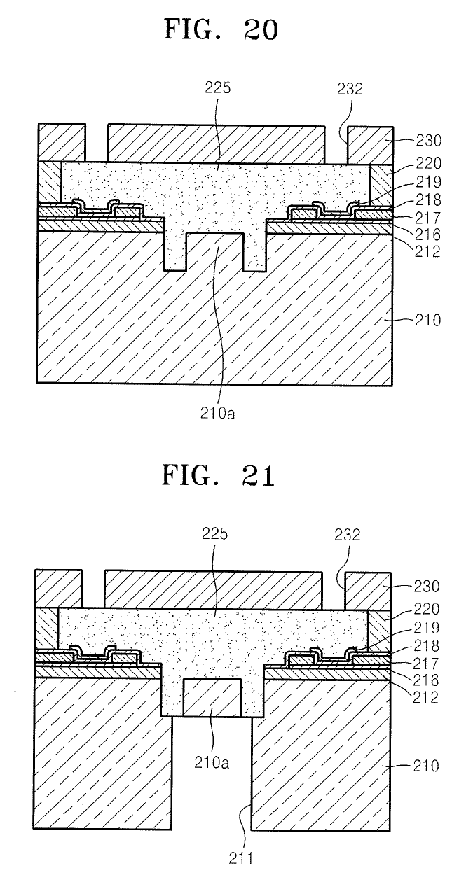

Referring to FIG. 18, a sacrifice layer 225 that fills the trenches 213b, the through hole 213a, and the ink chambers 222 is formed on the chamber layer 220. More specifically, the sacrifice layer 225 can be formed by curing a predetermined material after the predetermined material is coated on the structure of FIG. 16. In the present embodiment, since the island 210a surrounded by the trenches 213b and the at least one bridge 210b that connects the island 210a and the substrate 210 are formed on the upper part of the substrate 210, the amount of the sacrifice layer 225 that must be filled in the trenches 213b is greatly. Thus, the number of coating and curing processes for forming the sacrifice layer 225 is reduced, thereby simplifying the process of manufacturing the inkjet printhead. Also, the sacrifice layer 225 can be formed of a material, for example, a photoresist having an etch selectivity with respect to the substrate 210, the chamber layer 220, and a nozzle layer 230 (refer to FIG. 20).

Referring to FIG. 19, after the sacrifice layer 225 is formed, an operation of planarizing the sacrifice layer 225 and the chamber layer 220 can further be performed. Upper surfaces of the sacrifice layer 225 and the chamber layer 220 can be planarized using, for example, a CMP process. Referring to FIG. 20, a nozzle layer 230, in which a plurality of nozzles 232 are formed, is formed on the upper surfaces of the planarized chamber layer 220 and the sacrifice layer 225.

Referring to FIG. 21, an ink feed hole 111, to supply ink to the ink chambers 222 is formed by etching the lower part of the substrate 210 until the sacrifice layer 225 filled in the trenches 213b is exposed. The ink feed hole 211 can be formed to have a width greater than that of the island 210a. Finally, referring to FIGS. 22 and 23, when the sacrifice layer 225 that is filled in the trenches 213b, the through hole 213a, and the ink chambers 222 are removed, the manufacture of the inkjet printhead is completed. More specifically, when a predetermined etching solution is injected 225 through the nozzles 232 and the ink feed hole 211, the sacrifice layer 225 is selectively etched, and thus, is removed. In this process, since the island 210a is connected to the substrate 210 by the bridges 210b, the island 210a remains on the upper part of the ink feed hole 211. At this point, the ink feed hole 211 is connected to the trenches 213b, and thus, ink in the ink feed hole 211 is supplied to the ink chambers 222 through the trenches 213b and the through hole 213a.

As described above, in the method of manufacturing an inkjet printhead according to the above embodiment of the present general inventive concept, since the island 210a surrounded by the trenches 213b is formed in the upper part of the substrate 210, the amount of sacrifice layer 225 that must be filled in the trenches 213b is reduced. As a result, the number of coating and curing processes to form the sacrifice layer 225 can be reduced. Also, since the island 210a, connected to the substrate 210 by the bridges 210b, remains with the trenches 213b and supports the substrate 210, a rigidity of the inkjet printhead can be increased. Since ink in the ink feed hole 211 is supplied to the ink chambers 222 through a gap between the island 210a and the substrate 210, the entering of contaminating impurities in the ink into the ink chambers 222 can be prevented, by adjusting the gap to correspond to a diameter of the nozzles, thereby increasing the performance of the inkjet printhead.

The present general inventive concept has the following advantages.

First, since an island surrounded by trenches is formed on an upper part of a substrate, a number of coating and curing processes to form a sacrifice layer can be reduced. Therefore, a manufacturing process of the inkjet printhead can be simplified, thereby reducing manufacturing costs and increasing productivity of the inkjet printhead.

Second, if the island remains with the trenches in a removing process of the sacrifice layer, the island supports the substrate, thereby increasing a rigidity of the inkjet printhead.

Third, if the island remains with the trenches in a removing process of the sacrifice layer, the entering of impurities in ink into the ink chambers can be prevented, thereby increasing the performance of the inkjet printhead.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A method of manufacturing an inkjet printhead, comprising:
forming a chamber layer, in which a plurality of ink chambers is formed, on a substrate;
forming a trench and an island surrounded by the trench on an upper part of the substrate by etching an upper surface of the substrate to a predetermined depth;
forming a sacrifice layer on the chamber layer to fill the trench and the ink chambers;
forming a nozzle layer, in which a plurality of nozzles are formed, on the sacrifice layer and the chamber layer;
forming an ink feed hole by etching a lower part of the substrate until the sacrifice layer that is filled in the trenches is exposed; and
removing the sacrifice layer and the island.

2. The method of claim 1, wherein the island formed by the trenches has a width narrower than that of the ink feed hole.

3. The method of claim 2, wherein the removing of the sacrifice layer and the island comprises removing the island to an outside through the ink feed hole in the process of removing the sacrifice layer by etching.

4. The method of claim 1, further comprising:
planarizing upper surfaces of the sacrifice layer and the chamber layer after the sacrifice layer is formed.

5. The method of claim 1, further comprising:
forming an insulating layer on the substrate;
sequentially forming a plurality of heaters and electrodes on the upper surface of the insulating layer; and
forming a passivation layer covering the heaters and the electrodes on the insulating layer, wherein the forming of the insulating layer on the substrate takes place before the forming of the chamber layer on the substrate.

6. The method of claim 5, wherein the forming of the trench and the island comprises:
forming a through hole that exposes the upper surface of the substrate by sequentially etching the passivation layer and the insulating layer;
exposing and developing a photoresist after coating the photoresist to cover an upper surface of the substrate exposed through the through hole;
etching the substrate to a predetermined depth using the developed photoresist as an etch mask; and
removing the photoresist.

7. The method of claim 6, wherein the substrate is etched using a dry etching method.

8. The method of claim 6, wherein the trenches have a depth of 30 to 100 μm.

9. The method of claim 5, further comprising:
forming anti-cavitation layers on an upper surface of the passivation layer after the passivation layer is formed.

10. The method of claim 9, wherein the anti-cavitation layers are formed of Ta.

11. The method of claim 1, wherein the ink chambers are disposed facing each other at sides of the ink feed hole.

12. The method of claim 11, wherein the trenches are formed above the ink feed hole.

13. The method of claim 1, wherein the sacrifice layer is formed of a material having an etch selectivity with respect to the substrate, the chamber layer, and the nozzle layer.

14. A method of manufacturing an inkjet printhead comprising:
forming a chamber layer, in which a plurality of ink chambers is formed, on a substrate;
forming trenches to define an island between the trenches, and at least one bridge that connects the island and the substrate on an upper part of the substrate by etching the upper part of the substrate to a predetermined depth;
forming a sacrifice layer on the chamber layer to fill the trenches and the ink chambers;
forming a nozzle layer, in which a plurality of nozzles are formed, on the sacrifice layer and the chamber layer;
forming an ink feed hole by etching the lower part of the substrate until the sacrifice layer that is filled in the trenches is exposed; and
removing the sacrifice layer.

15. The method of claim 14, wherein the island formed by the trenches has a width narrower than that of the ink feed hole.

16. The method of claim 15, wherein the removing of the sacrifice layer comprises leaving the island connected to the substrate through the at least one bridge.

17. The method of claim 14, further comprising:
planarizing upper surfaces of the sacrifice layer and the chamber layer after the sacrifice layer is formed.

18. The method of claim 14, further comprising:
forming an insulating layer on the substrate;
sequentially forming a plurality of heaters and electrodes on the upper surface of the insulating layer; and
forming a passivation layer covering the heaters and the electrodes on the insulating layer,
wherein the forming of the insulating layer on the substrate takes place before the forming of the chamber layer on the substrate.

19. The method of claim 18, wherein the forming of the trenches, the island, and the bridge comprises:
forming a through hole that exposes the upper surface of the substrate by sequentially etching the passivation layer and the insulating layer;
exposing and developing a photoresist after coating the photoresist that covers the upper surface of the substrate exposed through the through hole;
etching the substrate to a predetermined depth using the developed photoresist as an etch mask; and
removing the photoresist.

20. The method of claim 19, wherein the substrate is etched using a dry etching method.

21. The method of claim 19, wherein the trenches have a depth of 30 to 100 μm.

22. The method of claim 14, further comprising:
forming anti-cavitation layers on an upper surface of the passivation layer after the passivation layer is formed.

23. The method of claim 14, wherein the ink chambers are disposed facing each other at sides of the ink feed hole.

24. The method of claim 23, wherein the trenches are formed above the ink feed hole.

25. The method of claim 14, wherein the sacrifice layer is formed of a material having an etch selectivity with respect to the substrate, the chamber layer, and the nozzle layer.
